(19) United States
(12) Patent Application Publication
(10) Pub. No.: US 2009/0048935 A1
(43) Pub. Date: Feb. 19, 2009

(54) Application program interface to manage gift cards and check authorizations

(75) Inventors: Sylvester La Blanc, Issaquah, WA (US); Kirk Blackwood, Seattle, WA (US); Josef Schauer, Seattle, WA (US); Tim Cooper, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/893,412

(22) Filed: Aug. 16, 2007

(51) Int. Cl. G06Q 20/00

(52) U.S. Cl. 705/17; 235/383; 705/14

(57) ABSTRACT

An application program interface to manage gift cards and check authorizations may be described. An apparatus may comprise a point of sale device having a processor coupled to a memory, the memory storing a point of sale host application object, a gift card service add-in object and a check service add-in object. The processor may execute the gift card service add-in object in response to application program interface commands to perform gift card service operations for the point of sale host application object. The processor may execute the check service add-in object to perform check service operations for the point of sale host application service. Other embodiments are described and claimed.

### BACKGROUND

Many businesses are moving to point of sale (POS) systems over traditional electronic cash register (ECR) systems. Effective POS systems provide more functionality than just customer checkout. They support such business services as merchandise planning, ordering and analysis; allow export of information to standard desktop software tools; and provide a convenient way to access customers' preferences and buying habits. In some cases, however, different types of retailers may need to implement different types of business services. For example, a larger retailer may require complex inventory management services, while smaller retailers may simply desire a way to better manage cash receipts. Consequently, to have a POS system natively support all potentially useful business services for all retailer types may be difficult, inefficient or expensive, particularly for smaller retailers that have no need for a given type of business service. Accordingly, there may be a substantial need for improved POS systems that are cost effective and yet robust enough to support retailers of varying size, needs and preferences.

### SUMMARY

Various embodiments are generally directed to POS systems. Some embodiments are particularly directed to techniques for customizing POS systems to provide certain business services. The POS system may be customized using various software objects that may be invoked via a set of application program interfaces (API) comprising part of a shared library of interfaces. In some embodiments, the software objects may be implemented as “add-in” objects in an add-in architecture or similar technique. Examples of such add-in objects may include add-in objects designed to support gift card service operations, check authorization service operations and other POS system or retail management system (RMS) operations.

In one embodiment, for example, a POS system may include a POS device having a processing system. The processing system may include a processor coupled to a memory unit. The memory unit may be arranged to store various software applications or objects, such as a POS host application object, a gift card service add-in object, a check service add-in object, and so forth. The processor may be arranged to execute the gift card service add-in object in response to one or more API commands to perform various gift card service operations for the POS host application object. The processor may further be arranged to execute the check service add-in object to perform various check service operations for the POS host application service. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of a point of sale system.

FIG. 2 illustrates one embodiment for a first application program interface.

FIG. 3 illustrates one embodiment for a second application program interface.

FIG. 4 illustrates one embodiment for a third application program interface.

FIG. 5 illustrates one embodiment of a first logic flow.

FIG. 6 illustrates one embodiment of a second logic flow.

FIG. 7 illustrates one embodiment of a computing system architecture.

### DETAILED DESCRIPTION

Various embodiments are directed to managing various software objects to provide customized functions or operations for a POS system, such as a POS host application program. In some embodiments, a POS host application program may be customized for a unique set of retail requirements using one or more software objects. The software objects may be implemented as “add-in” objects in accordance with a given add-in architecture or similar technique. The term add-in has different meanings depending on context, but typically refers to any software component that is dynamically loaded by an application. For example, a POS host application program may be customized with various add-in objects to process different retail transactions for different tenders, such as cash tenders, credit card tenders, debit card tenders, check tenders, gift card tenders, and so forth.

In various embodiments, a POS system may need to process gift card and check authorization transactions using various authorization techniques and providers. Processing of gift cards and check authorization includes performing operations related to replenishment, activation, or redemption within the context of a sales transaction, return, or void. Such transactions may include multiple tenders, such as gift card, debit card, credit card, check, cash, and so forth. Such transactions may also include multi-tender transactions, such as multiple gift card tenders from the same or different gift card providers. It is possible, that one provider may approve a gift card or check authorization transaction, only to have another tender (e.g., of a different tender type, the same or different gift card provider) reject an authorization request, thus invalidating any previously validation operations. Different gift cards, check authorizations, and different providers all may vary in operations and capabilities. Also, because there is a great number of different requirements that may be needed for different gift cards and check authorizations, a way of extending a POS application to handle these differences without changing the core application may be needed.

To solve these and other problems, various embodiments allow different add-in objects to extend the application for gift card tender processing. Some embodiments define a standard set of API that establish a set of contracts between a POS host application and different add-in objects to enhance or extend the services or features offered by the POS host application. In one embodiment, for example, a POS host application program may be customized with a gift card service add-in object to support various types of gift card service transactions. The gift card service add-in object may be arranged to allow different gift card providers to extend the POS host application to support gift card processing within their business context. In addition to the API, various semantics associated with gift card processing and related functionality are defined. In one embodiment, for example, a POS host application program may be customized with a check authorization service add-in object to support various types of check authorization service transactions. The check service add-in object may be arranged to allow different check providers to extend the POS host application to support check processing within their business context. Other types of add-in objects may be implemented to provide other business services as desired for a given implementation.

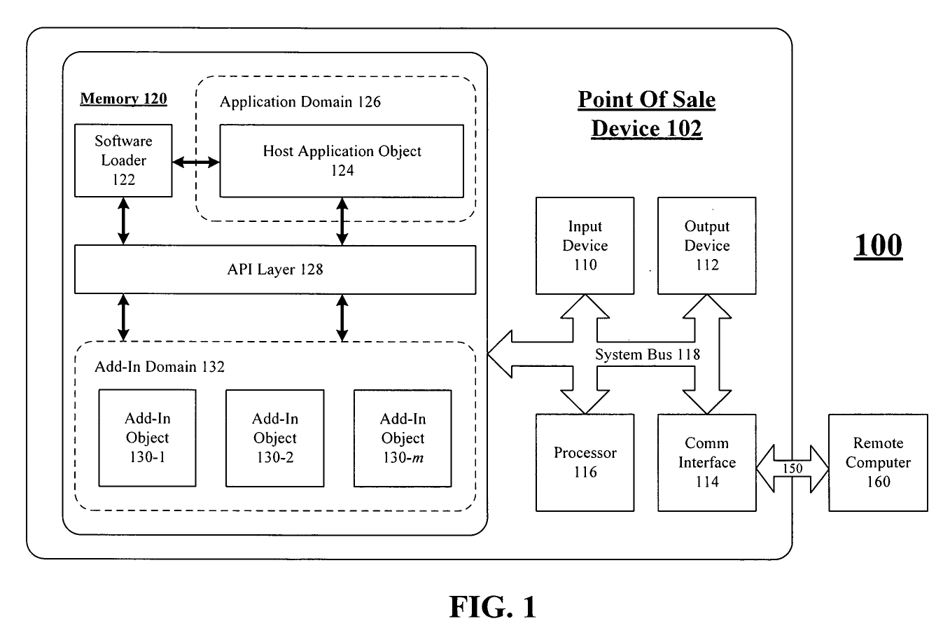

FIG. 1 illustrates one embodiment of a POS system 100. The POS system 100 may represent a general system architecture suitable for implementing various embodiments. The POS system 100 may comprise multiple elements. An element may comprise any physical or logical structure arranged to perform certain operations. Each element may be implemented as a hardware element, a software element, or any combination thereof, as desired for a given set of design parameters or performance constraints. Examples of hardware elements may include without limitation devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include without limitation any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the POS system 100 as shown in FIG. 1 has a limited number of elements in a certain topology, it may be appreciated that the POS system 100 may include more or less elements in alternate topologies as desired for a given implementation. The embodiments are not limited in this context.

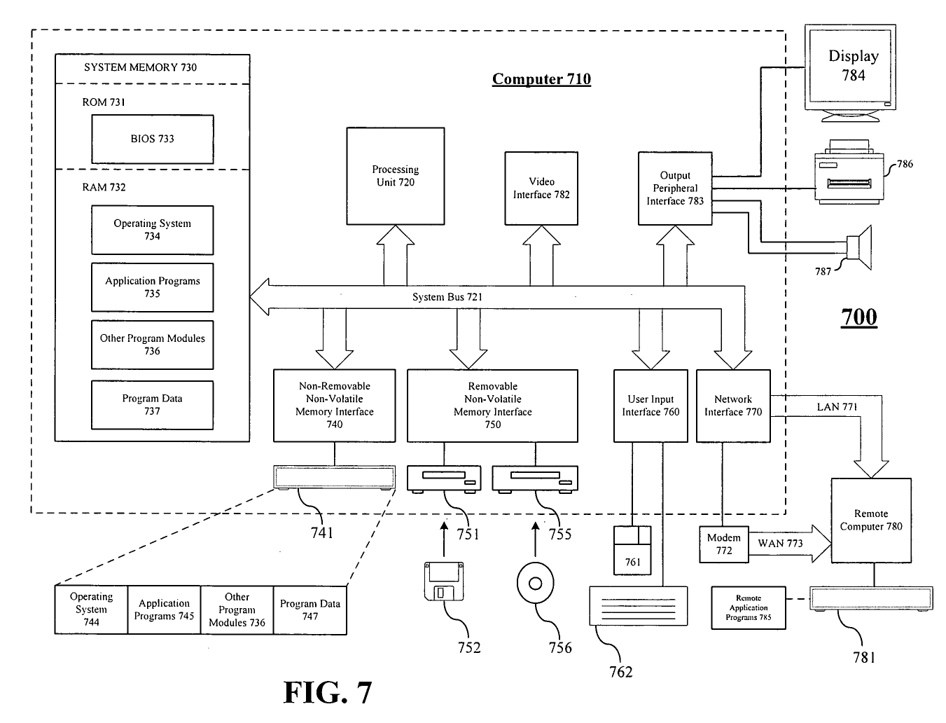

As shown in the illustrated embodiment of FIG. 1, the POS system 100 comprises a POS device 102 capable of communication with a remote computer 160 over a wired or wireless communication channel 150 via a communications interface 114. The POS device 102 may include one or more input devices 110, output devices 112, communication interfaces 114, processors 116, and memory units 120, all connected by a system bus 118. The memory 120 may include a software loader 122, an application object 124, an application domain 126, API layer 128, add-in objects 130-1-m, and an add-in domain 132. In various embodiments, the POS device 102 may be implemented as a computing device, such as a computer, server, workstation, laptop, handheld computer, and so forth. A more detailed description of a computing device suitable for implementing the POS device 102, including certain parts of the illustrated embodiment shown in FIG. 1, may be described with reference to FIG. 7.

In various embodiments, the POS device 102 may include a processing system comprising at least the processor 116 and the memory 120. The memory 120 may include various software elements to provide various types of POS services for the POS device 120. The processor 116 may execute or manage the various software elements stored by the memory 120.

In various embodiments, the POS device 102 may receive information for use by the software elements of the memory 120 from one or more input devices 110. The input devices 110 may include any input device suitable for use with the POS device 102 to receive, retrieve or otherwise input tender information for a retail transaction into the POS device 102. Examples of the input devices 110 may include without limitation a barcode scanner, keyboard, keypad, POS keyboard, magnetic stripe reader, check document scanner, microphone, magnetic ink character recognition (MICR) reader, and so forth.

In various embodiments, the POS device 102 may send information from the software elements of the memory 120 to one or more output devices 112. The output devices 112 may include any output device suitable for use with the POS device 102 to send, display or otherwise output tender information for a retail transaction for the POS device 102. Examples of the output devices 112 may include without limitation a display, printer, speaker, and so forth.

In various embodiments, the memory 120 for the POS device 102 may include one or more host application objects 124. The host application object 124 may comprise any application program suitable for use with the POS device 102 to provide native POS services. An example for a host application object 124 may comprise a MICROSOFT® DYNAMICS RETAIL MANAGEMENT SYSTEM (RMS) or MICROSOFT DYNAMICS POINT OF SALE and accompanying equipment for a POS system. RMS is a software package designed to allow retailers a general POS solution that can be adapted to meet unique or customized retail requirements.

In various embodiments, the memory 120 for the POS device 102 may include one or more add-in objects 130-1-m. The add-in objects 130-1-m may comprise any software objects suitable for use with the host application object 124. More particularly, the add-in objects 130-1-m may refer to any software component that is dynamically loaded by the host application object 124 to provide enhanced or additional POS features or services to those provided by the host application object 124.

During runtime, the processor 116 may execute the software loader 122 to load the host application object 124 to the application domain 126 for providing various POS services. Similarly, the processor 116 may execute the software loader 122 to load one or more add-in objects 130-1-m to the add-in domain 132 for providing various enhanced or additional POS services for the host application object 124. Various add-in models may be used to load and manage the host application object 124 and the add-in objects 130-1-m depending on a given Model Add-In Framework (MAF). An add-in model may comprise an interface or set of interfaces defined in a shared library, as represented by API layer 128, where the add-in implements the interface and there is a method whereby the host application object 124 is able to discover and load an add-in object 130-1-m. Examples of various add-in models may include a tightly coupled add-in model, an isolation boundary add-in model, a version-resilient add-in model, and a cross-process add-in model. A tightly coupled add-in model is where an add-in object 130-1-m is loaded into the same application domain 126 as the application object 124. In this case, both the host application object 124 and the add-in object 130-1-m reside in the same application domain 126. An isolation boundary add-in model is where an add-in object 130-1-m is loaded into a separate add-in domain 132 from the host application object 124. In this case, the host application object 124 and the add-in object 130-1-m reside in different domains, such as the application domain 126 and the add-in domain 132, respectively. A version-resilient add-in module is similar to the isolation boundary add-in model using separate domains 126, 132, with the addition of a stable contract between the domains 126, 132, and a proxy and an adaptor implemented for the respective domains 126, 132. A cross-process add-in model is similar to a version-resilient add-in module, except that the host application object 124 and the add-in object 130-1-m each run on a separate thread or process.

In the illustrated embodiment of FIG. 1, the software loader 122 loads the host application object to the application domain 126, and the add-in objects 130-1-m to the add-in domain 132. The different domains 126, 132 provide an isolation boundary for security, reliability, versioning, and for unloading assemblies within the Common Language Runtime (CLR). The isolation of the various software objects may be important for a number of reasons, not the least of which is application security. Classes may be used to let the host application object 124 to use the software loader 122 to load and unload add-in objects 130-1-m dynamically. The default behavior loads each add-in object 130-1-m into its own add-in domain 132, which provides isolation between the host application object 124 and the add-in object 130-1-m, as well as between other add-in objects. The domain isolation prevents an add-in object 130-1-m from interfering with the host application object 124, and enables the add-in object 130-1-m to be unloaded from the memory 120. Other add-in loading models enable various levels of isolation by allowing multiple add-in objects 130-1-m to be loaded into the same application domain, or even the host's application domain 126. Add-in objects 130-1-m may even be loaded into an application domain in a process outside of the host's application process, which provides the greatest amount of isolation. Although the illustrate embodiment of FIG. 1 shows a given add-in model by way of example and not limitation, it may be appreciated that any add-in model may be used as desired for a given implementation.

The various embodiments generally provide an extensibility model for developers to create and plug-in various add-in components for the POS host application object 124. In one embodiment, for example, the host application object 124 may utilize the add-in objects 130-1-m to process various types of tender information related to different types of tenders for a retail transaction. For example, the add-in objects 130-1-m can extend the POS functionality of the host application object 124 with additional payment, gift card, and check processing services beyond what the host application object 124 natively supports. In one embodiment, for example, the host application object 124 may be customized with a gift card service add-in object 130-1 to support various types of gift card service transactions. In one embodiment, for example, the host application program 124 may be customized with a check authorization service add-in object 130-2 to support various types of check authorization service transactions. Other types of add-in objects may be implemented to provide other business services as desired for a given implementation.

Once loaded into their respective domains 126, 132, the host application object 124 may utilize the add-in objects 130-1-m to perform customized processing via the API layer 128. The API layer 128 may comprise an API software library of software objects interoperable with corresponding defined API commands to support a desired POS service. In general, an API is a computer process or technique that allows other processes to work together. In the familiar setting of a personal computer running an operating system and various applications such as MICROSOFT WORD®, an API allows the application to communicate with the operating system. An application makes calls to the operating system API to invoke operating system services. The actual code behind the operating system API is located in a collection of dynamic link libraries (DLLs).

Similar to other software elements, an API can be implemented in the form of computer executable instructions whose services are invoked by another software element. The computer executable instructions can be embodied in many different forms. Eventually, instructions are reduced to machine-readable bits for processing by a computer processor. Prior to the generation of these machine-readable bits, however, there may be many layers of functionality that convert an API implementation into various forms. For example, an API that is implemented in C++ will first appear as a series of human-readable lines of code. The API will then be compiled by compiler software into machine-readable code for execution on a processor, such as processing unit 202, for example.

The proliferation of different programming languages and execution environments have brought about the need for additional layers of functionality between the original implementation of programming code, such as an API implementation, and the reduction to bits for processing on a device. For example, a computer program initially created in a high-level language such as C++ may be first converted into an intermediate language such as MICROSOFT® Intermediate Language (MSIL). The intermediate language may then be compiled by a Just-in-Time (JIT) compiler immediately prior to execution in a particular environment. This allows code to be run in a wide variety of processing environments without the need to distribute multiple compiled versions. In light of the many levels at which an API can be implemented, and the continuously evolving techniques for creating, managing, and processing code, the embodiments are not limited to any particular programming language or execution environment.

In general, interfaces supported by objects are generally thought of as a contract between the object and its clients. The object promises to support the interface's methods as the interface defines them, and the client applications promise to invoke the methods correctly. Thus, an object and the clients must agree on a way to explicitly identify each interface, a common way to describe, or define, the methods in an interface, and a concrete definition of how to implement an interface. Objects can therefore be described in terms of the interface parameters that they inherit, as well as the class parameters that they inherit. Where a class of objects has a function for writing data to a file, for example, an instance that inherits the class will also be able to write data to a file, as well as any additional features and functions provided in the instance. Where a class supports a particular interface, an instance of the class inherits the “contract” and therefore also supports the interface. The objects through which various aspects of the embodiments are implemented generally conform to these programming principles and understandings of the definitions for objects, classes, inheritance, and interfaces. It should be clear, however, that modifications and improvements to object-oriented programming techniques are constantly occurring, and the embodiments are not limited to objects of a particular type or with any specific features. The API provided can be implemented through objects of any kind now in use or later developed.

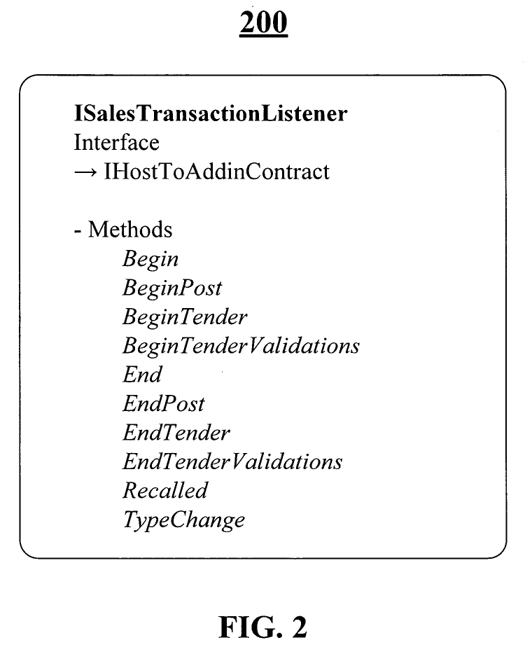

FIG. 2 illustrates an API 200. The API layer 128 may implement various contracts and/or interfaces to implement the extensibility provided by the add-in objects 130-1-m. In one embodiment, for example, the API layer 128 may include, among others, an IHostToAddin Contract to allow the host application object 124 to call the add-in objects 130-1-m. In addition, the API layer 128 may include an ISalesTransactionListener contract to allow the add-in objects 130-1-m to be invoked at certain points in the sales transaction. The ISalesTransactionListener contract is derived from the IHostToAddinContract. The API 200 may represent the ISalesTransactionListener interface. The ISalesTransactionListener interface has various associated methods. Some of the methods for the API 200 may be reproduced by Table 1 as follows:

TABLE 1

| NAME | SUMMARY |
|---|---|
| Begin( ) | Invoked at the beginning of a sales transaction. |
| Recalled(SalesTransactionType type) | Invoked when a transaction is recalled. |
| | SalesTransactionType will be (1 = Sales, 2 = Return |
| | or 3 = Void). |
| BeginTender( ) | Invoked when the cashier begins to |
| | tender the transaction. |
| BeginTenderValidations( ) | Invoked when the tender validation |
| | process begins. Any calls to payment |
| | processors for validation of payment |
| | types will take place after this. |
| EndTenderValidations(bool success) | Invoked when the tender validation |
| | process ends. If success is true, the |
| | tender process is complete (EndTender |
| | will be invoked next). Otherwise, the |
| | cashier is returned to the tender screen. |
| EndTender (bool cancelled) | Invoked when the tender process is |
| | complete. If cancelled is false, posting of |
| | the sales transaction will occur next. |
| | Otherwise, the cashier will be returned to |
| | the transaction screen. |
| BeginPost ( ) | Posting of the sales transaction is beginning. |
| EndPost(bool success) | Posting of the sales transaction is |
| | completed successfully (if success is true). |
| End (bool aborted) | The transaction is ended. If aborted is |
| | true, the transaction is logged as an aborted transaction |

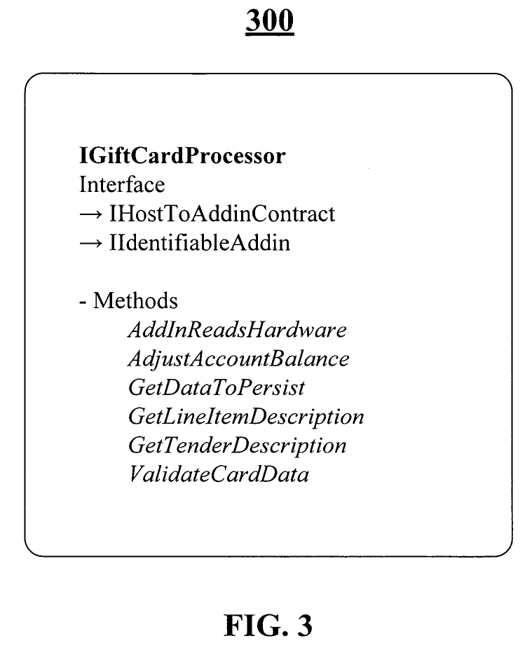

The ISalesTransactionListener interface and various associated methods may be used, for example, to allow an add-in object 130-1-m to be invoked at certain points in the sales transaction. In one embodiment, for example, the host application object 124 may use the ISalesTransactionListener interface and various associated methods to implement the gift card service add-in object 130-1 to support various types of gift card service transactions, as described with reference to FIG. 3.

FIG. 3 illustrates an API 300. The API 300 may represent an IGiftCardProcessor interface. The host application object 124 may invoke an API command corresponding to a gift card service add-in object 130-1 from a software library of the API layer 128. The gift card service add-in object 130-1 may be arranged to process a gift card tender with gift card information from a gift card by a POS application, such as the host application program 124.

In one embodiment, for example, the API layer 128 may include, among others, an IGiftCardProcessor interface to allow the host application object 124 to call the gift card service add-in object 130-1. The gift card service add-in object 130-1 allows development of a generic code for handling a plethora of gift card scenarios, workflows and options. They are not specific to any payment provider's requirements, but instead are intended to provide a generic solution regardless of the requirements imposed by the provider. The interface allows an add-in developer to enhance or add gift card services to the host application object 124. The IGiftCardProcessor interface is derived from an IHostToAddinContract and an IIdentifiableAddin contract.

The IGiftCardProcessor interface has various associated methods. In one embodiment, for example, the IGiftCardProcessor interface has an associated method as follows:
AddInReadsHardware( ): Bool.
   When called this method is designed to return a value to indicate whether the gift card service add-in object reads gift card information from the gift card. When the gift card service add-in object 130-1 returns FALSE for this, the host application program 124 will be responsible for reading the gift card data.

In one embodiment, the IGiftCardProcessor interface has an associated method:

ValidateCardData(IDictionaryContract hostCardData,
IPersistGiftCardEntry persistData) : bool.

When called this method is designed to validate gift card information from the gift card. This method is typically invoked when a cashier sells or redeems a gift card. The gift card service add-in object 130-1 should display an error message and return FALSE if there is any problem, such as a bad card swipe, for example.

In one embodiment, the IGiftCardProcessor interface has an associated method:
GetLineItemDescription(IDictionaryContract hostCardData): String[ ].
   When called this method is designed to return gift card description information for the gift card. When the gift card is on the transaction screen, this function will be called to retrieve any text the add-in developer desires to display on the transaction screen (e.g., up to 3 lines).

In one embodiment, the IGiftCardProcessor interface has an associated method:
GetTenderDescription(IDictionaryContract hostCardData): String[ ].
   When called this method is designed to return description information for the gift card tender. When the gift card is on the payment screen, this function will be called to retrieve any text the add-in developer desires to display as receipt text.

In one embodiment, the IGiftCardProcessor interface has an associated method:

AdjustAccountBalance(IDictionaryContract hostCardData, decimal
amount, out decimal authorizedAmount) : Bool.

When called this method is designed to adjust an account balance for an account corresponding to the gift card. This function is typically called during tender validation. When the amount is positive, money should be added to the identified gift card. When the amount is negative, money should be redeemed from the gift card. The authorizedAmount should be set to the actual amount authorized. For a partial authorization, the magnitude of authorizedAmount should be less than amount and the gift card service add-in object 130-1 should return TRUE. If there are any problems, the add-in developer should display an error message and return FALSE. The gift card service add-in object 130-1 should detect if a call was previously made to this function for the same card during tender validation for the current sales transaction, and if so, report the error.

In one embodiment, the IGiftCardProcessor interface has an associated method:
GetDataToPersist(IDictionaryContract hostCardData): Byte[ ].
   When called this method is designed to return posted information for the gift card. This function is typically invoked by the host application program 124 during transaction posting. The gift card service add-in object 130-1 should return any data to be posted with the entry for this gift card. This data will be returned in hostCardData for returns or voids against the gift card.

The API layer 128 in general, and the gift card service add-in object 130-1 in particular, may be further described by way of various exemplary sample gift card scenarios. The example scenarios assume the host application object 124 is reading the POS hardware (e.g., the AddInReadsHardware property is set to false). The example scenarios also assume that the gift service card service add-in object 130-1 chooses to perform the actual account adjustments at the time the call is made and therefore must undo the adjustment if tender validation fails (e.g., ISalesTransactionListener. EndTender Validations(false)).

In a first gift card scenario, assume that the POS device 102 is used to process a gift card tender for a retail transaction where the gift card sell has an error on the AdjustAccountBalance method. In this case, the ISalesTransactionListener.Begin is invoked. Assume the cashier selects a gift card to sell for $1000.00. The cashier swipes the gift card via a gift card reader (e.g., the magnetic swipe reader) implemented as the input device 110 for the POS device 102. The host application object 124 reads the gift card information swiped from the gift card. The host application object 124 creates a new globally unique identifier (GUID) for the EntryId, and populates the track data and account number into hostCardData. The host application object 124 invokes ValidateCardData passing the hostCardData. The gift card service add-in object 130-1 validates the card swipe data and returns TRUE. The cashier hits a button from a POS keyboard (input device 110) to tender the transaction, and the ISalesTransactionListener. BeginTender is invoked. The cashier enters the tender (cash) and presses OK on the POS keyboard, and the ISalesTransactionListener.BeginTender Validations is invoked. The host application object 124 invokes the add-in call AdjustAccountBalance with an amount of $1000.00 and hostCardData. The gift card service add-in object 130-1 currently limits gift card values at $500.00, so it pops up a graphic user interface (GUI) view notifying the cashier and returns FALSE. The ISalesTransactionListener.EndTenderValidations is invoked with success set equal to FALSE. The host application object 124 returns to the tender screen. The cashier escapes from the tender screen, and the ISalesTransactionListener.EndTender with cancelled is invoked. The cashier changes the dollar amount to $500.00. The cashier hits a button from a POS keyboard (input device 110) to tender the transaction, and the ISalesTransactionListener.BeginTender is invoked. The cashier enters the tender (cash) and presses OK on the POS keyboard, and the ISalesTransactionListener.BeginTenderValidations is invoked. The host application object 124 invokes the gift card service add-in object 130-1 call AdjustAccountBalance with an amount of $500.00 and hostCardData. The gift card service add-in object 130-1 makes the processor call, and accepts the amount. The gift card service add-in object 130-1 returns TRUE to the AdjustAccountBalance function call. The ISalesTransactionListener.EndTender Validations(success=TRUE), the EndTender(cancelled=FALSE), and BeginPost are called in sequence. The host application object 124 calls GetDataToPersist and the gift card service add-in object 130-1 returns any data that it wishes to store in the database and that may be used by the add-in to process subsequent voids/returns. The ISalesTransactionListener.EndPost is then called.

In a second gift card scenario, assume that the POS device 102 is used to process a gift card tender for a retail transaction to void a transaction. In this case, the ISalesTransactionListener.Begin is invoked. The cashier recalls the previous transaction to void. The host application program 124 invokes the ISalesTransactionListener. TypeChange method with void to notify the gift card service add-in 130-1 that a void is in progress. The cashier tenders cash and hits OK on the tender screen, and the ISalesTransactionListener.BeginTender and BeginTenderValidations are called respectively. The host application object 124 invokes AdjustAccountBalance with hostCardData containing GiftCardEntryID from the previous transaction and PersistedData that the gift card service add-in object 130-1 stored in the previous transaction. The gift card service add-in object 130-1 makes the processor call, accepts the amount, calls using the IGiftCardTransactionInfo interface to store the transaction ID and any other transactional information desired. It is worthy to note that this information is typically not stored until the transaction is posted. The gift card service add-in object 130-1 returns TRUE to the AdjustAccountBalance function call. The ISalesTransactionListener.EndTender Validations(success=TRUE), the EndTender(cancelled=FALSE), and the BeginPost methods are then called in sequence. The gift card service add-in object 130-1 calls GetDataToPersist and returns any data that it wishes to store in the database that may be used by the gift card service add-in object 130-1 to process subsequent voids/returns. The ISalesTransactionListener. EndPost is finally called.

In a third gift card scenario, assume that the POS device 102 is used to process a gift card tender for a retail transaction having a gift sale, multi-tender gift card redemption, and debit card with debit card failure. In this case, the ISalesTransactionListener.Begin method is invoked. The cashier selects a first gift card to sell for $100.00. The host application object 124 reads swipe data. The host application object 124 creates a new GUID for the GiftCardEntryId and populates the track data and account number into hostCardData. The host application object 124 invokes ValidateCardData passing hostCardData. The gift card service add-in object 130-1 validates the card swipe data and returns TRUE. The cashier hits the button to tender the transaction, and the ISalesTransactionListener.BeginTender is invoked. The cashier enters a second gift card for redemption and sets an amount of $50.00. The host application object 124 reads the swipe data. The host application object 124 creates a new GUID for the GiftCardEntryId and populates the track data and account number into hostCardData. The host application object 124 invokes ValidateCardData passing hostCardData. The gift card service add-in object 130-1 validates the card swipe data and returns TRUE. The cashier enters an amount for a debit card for $50.00. The cashier hits OK on the tender screen, and the ISalesTransactionListener.BeginTenderValidations method is invoked. The host application object 124 invokes the add-in call AdjustAccountBalance with an amount of $100.00 for the first gift card. The gift card service add-in object 130-1 makes the processor call, accepts the amount, calls using the IGiftCardTransactionInfo interface to store the transaction ID and any other transactional information desired. It is worthy to note that this information is typically not stored until the transaction is posted. The gift card service add-in object 130-1 returns TRUE to the AdjustAccountBalance function call. The cashier hits OK on the tender screen, and the ISalesTransactionListener.BeginTenderValidations method is invoked. The host application object 124 invokes the add-in call AdjustAccountBalance with an amount of −$50.00 for the second gift card. The gift card service add-in object 130-1 makes the processor call, accepts the amount, calls using the IGiftCardTransactionInfo interface to store the transaction ID and any other transactional information desired. It is worthy to note that this information is typically not stored until the transaction is posted. The gift card service add-in object 130-1 returns TRUE to the AdjustAccountBalance function call. At this point, assume the debit card processing fails. The ISalesTransactionListener. EndTenderValidation(success=FALSE) is invoked. The gift card service add-in object 130-1 monitors this and performs voids for the first gift card and the second gift card. The host application program 124 returns to the tender screen, where the cashier may cancel the transaction or change the debit tender and re-run it.

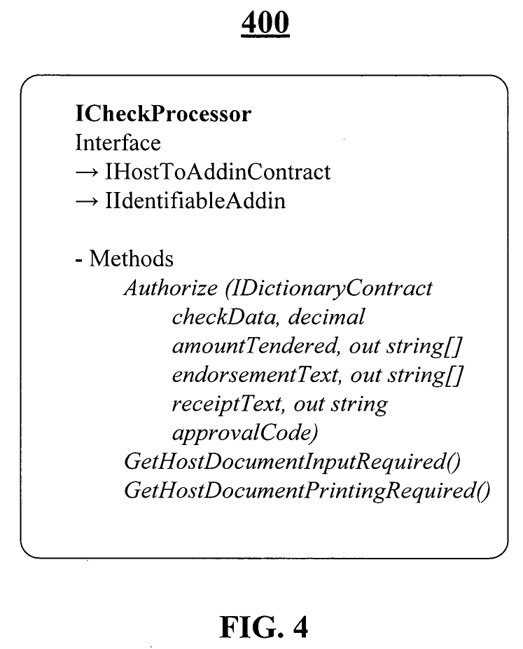

FIG. 4 illustrates an API 400. The API 400 may represent an ICheckProcessor interface. The host application object 124 may invoke an API command corresponding to a check service add-in object 130-2 from a software library of the API layer 128. The check service add-in object 130-2 may be arranged to process a check tender for a check by a POS application, such as the host application object 124.

In one embodiment, for example, the API layer 128 may include, among others, an ICheckProcessor interface to allow the host application object 124 to call the check service add-in object 130-2. The check service add-in object 130-2 allows development of a generic code for handling a plethora of check processing scenarios, workflows and options. They are not specific to any payment provider's requirements, but instead are intended to provide a generic solution regardless of the requirements imposed by the provider. The interface allows an add-in developer to enhance or add check processing services to the host application object 124. The ICheckProcessor interface is derived from the IHostToAddin Contract and the IIdentifiableAddin contract.

The ICheckProcessor interface has various associated methods. In one embodiment, for example, the ICheckProcessor interface has an associated method as follows:

Authorize( IDictionaryContract checkData, decimal amountTendered, out
string[ ] endorsementText, out string[ ] receiptText, out string
approvalCode) : bool.

When called this method is designed to authorize a check document based on document information and tender amount. The check service add-in object 130-2 authorizes a document, with the given document properties and tender amount, and passes out an array of printable text for the back of the document, an array of printable text for the receipt, a storable approval code, and returning whether or not authorization was successful.

In one embodiment, for example, the ICheckProcessor interface has an associated method as follows:
GetHostDocumentInputRequired( ): Int32.
   When called this method is designed to return configuration information to indicate whether check document information is retrieved by the check service add-in object 130-2 or the host application object 124. This method gets whether or not the check service add-in object 130-2 requires document information from the host application object 124. If the check service add-in object 130-2 intends for the host application object 124 to interact with the POS hardware and pass those results on as part of an authorization request, it should return TRUE. If the check service add-in object 130-2 intends to handle interacting with hardware (e.g., an MICR reader) on its own rather than relying on the host application object 124, it should return FALSE. In this case the host application object 124 will not communicate with any POS hardware before invoking the check service add-in object 130-2.

In one embodiment, for example, the ICheckProcessor interface has an associated method as follows:
GetHostDocumentPrintingRequired( ): Int32.

When called this method is designed to return configuration information to indicate whether printing is handled by the check service add-in object 130-2 or the host application object 124. This method gets whether or not the check service add-in object 130-2 needs the host application object 124 to perform any printing (e.g., to output device 112). If TRUE, the host application object 124 will prepare the printer to print during the check authorization flow using text supplied by the out-parameters of the Authorize method. If FALSE, the host application object 124 will not attempt to prepare the printer during the check authorization flow.

Operations for the POS system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the POS system 100 or alternative elements as desired for a given set of design and performance constraints.

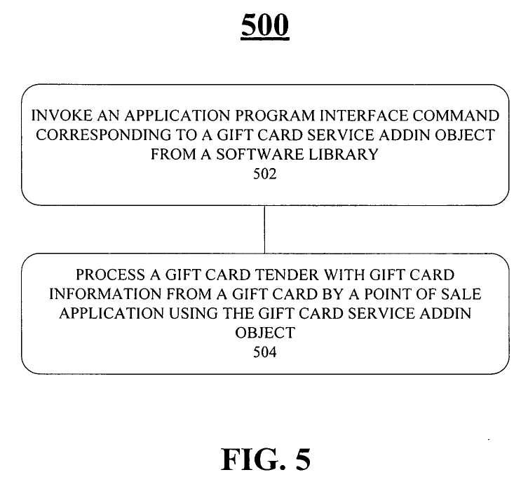

FIG. 5 illustrates a logic flow 500. The logic flow 500 may be representative of the operations executed by one or more embodiments described herein. As shown in FIG. 5, the logic flow 500 may invoke an API command corresponding to a gift card service add-in object from a software library at block 502. The logic flow 500 may process a gift card tender with gift card information from a gift card by a POS application using the gift card service add-in object at block 504. The embodiments are not limited in this context.

In one embodiment, the logic flow 500 may invoke an API command corresponding to a gift card service add-in object from a software library at block 502. For example, the software loader 122 may load the host application object 124 to the host application domain 126. The software loader 122 may load the gift card service add-in object 130-1 to the add-in domain 132. The host application object 124 may invoke an API command from the API layer 128, such as API 300, corresponding to the gift card service add-in object 130-1.

In one embodiment, the logic flow 500 may process a gift card tender with gift card information from a gift card by a POS application using a gift card service add-in object at block 504. For example, the host application object 124 may process a gift card tender with gift card information from one or more gift cards using the gift card service add-in object 130-1. Examples of gift card processing may include performing operations related to replenishment, activation, or redemption within the context of a sales transaction, return, or void. Such transactions may include multiple tenders, such as gift card, debit card, credit card, check, cash, and so forth. Such transactions may also include multi-tender transactions, such as multiple gift card tenders from the same or different gift card providers.

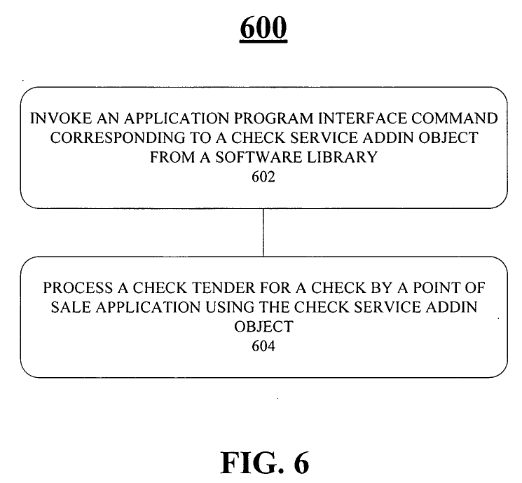

FIG. 6 illustrates a logic flow 600. The logic flow 600 may be representative of the operations executed by one or more embodiments described herein. As shown in FIG. 6, the logic flow 600 may invoke an application program interface command corresponding to a check service add-in object from a software library at block 602. The logic flow 600 may process a check tender for a check by a point of sale application using the check service add-in object at block 604. The embodiments are not limited in this context.

In one embodiment, the logic flow 600 may invoke an application program interface command corresponding to a check service add-in object from a software library at block 602. For example, the software loader 122 may load the host application object 124 to the host application domain 126. The software loader 122 may load the check service add-in object 130-2 to the add-in domain 132. The host application object 124 may invoke an API command from the API layer 128, such as API 400, corresponding to the check service add-in object 130-2.

In one embodiment, the logic flow 600 may process a check tender for a check by a POS application using a check service add-in object at block 604. For example, the host application object 124 may process a check tender for a check using the check service add-in object 130-2. Examples of check processing may include performing operations related to authorizing, authenticating or voiding within the context of a sales transaction. Such transactions may include multiple tenders, such as gift card, debit card, credit card, check, cash, and so forth. Such transactions may also include multi-tender transactions, such as multiple check tenders from the same or different check providers.

FIG. 7 illustrates a block diagram of a computing system architecture 700 suitable for implementing various embodiments, including the POS system 100. It may be appreciated that the computing system architecture 700 is only one example of a suitable computing environment and is not intended to suggest any limitation as to the scope of use or functionality of the embodiments. Neither should the computing system architecture 700 be interpreted as having any dependency or requirement relating to any one or combination of components illustrated in the exemplary computing system architecture 700.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 7, the computing system architecture 700 includes a general purpose computing device such as a computer 710. The computer 710 may include various components typically found in a computer or processing system. Some illustrative components of computer 710 may include, but are not limited to, a processing unit 720 and a memory unit 730. The processing unit 720 may be representative of the processor 116, and the memory unit 730 may be representative of the memory unit 120, both of which are shown and described with reference to FIG. 1.

In one embodiment, for example, the computer 710 may include one or more processing units 720. A processing unit 720 may comprise any hardware element or software element arranged to process information or data. Some examples of the processing unit 720 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 720 may be implemented as a general purpose processor. Alternatively, the processing unit 720 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 710 may include one or more memory units 730 coupled to the processing unit 720. A memory unit 730 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 710. The embodiments are not limited in this context.

In one embodiment, for example, the computer 710 may include a system bus 721 that couples various system components including the memory unit 730 to the processing unit 720. The system bus 721 may be representative of the system bus 118 as shown and described with reference to FIG. 1. A system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 710 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 700. Examples of computer readable media for computing system architecture 700 may include, but are not limited to, volatile and/or nonvolatile memory such as ROM 731 and RAM 732. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 730 includes computer storage media in the form of volatile and/or nonvolatile memory such as ROM 731 and RAM 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 784 or other type of display device is also connected to the system bus 721 via an interface, such as a video processing unit or interface 782. In addition to the monitor 784, computers may also include other peripheral output devices such as speakers 787 and printer 786, which may be connected through an output peripheral interface 783.

The computer 710 may operate in a networked environment using logical connections to one or more remote computers, such as a remote computer 780. The remote computer 780 may be a personal computer (PC), a server, a router, a network PC, a peer device or other common network node, and typically includes many or all of the elements described above relative to the computer 710, although only a memory storage device 781 has been illustrated in FIG. 7 for clarity. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other technique suitable for establishing communications over the WAN 773, such as the Internet. The modem 772, which may be internal or external, may be connected to the system bus 721 via the network interface 770, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other techniques for establishing a communications link between the computers may be used. Further, the network connections may be implemented as wired or wireless connections. In the latter case, the computing system architecture 700 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system architecture 700 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
invoking an application program interface command corresponding to a gift card service add-in object from a software library; and
processing a gift card tender with gift card information from a gift card by a point of sale application using the gift card service add-in object.

2. The method of claim 1, comprising loading a host application object to a host application domain.

3. The method of claim 1, comprising loading the gift card service add-in object to an add-in domain.

4. The method of claim 1, comprising returning a value to indicate whether the gift card service add-in object reads gift card information from the gift card.

5. The method of claim 1, comprising validating gift card information from the gift card.

6. The method of claim 1, comprising returning gift card description information for the gift card.

7. The method of claim 1, comprising adjusting an account balance for an account corresponding to the gift card.

8. The method of claim 1, comprising returning posted information for the gift card.

9. An article comprising a machine-readable storage medium containing instructions that if executed enable a system to:
invoke an application program interface command corresponding to a check service add-in object from a software library; and
process a check tender for a check by a point of sale application using the check service add-in object.

10. The article of claim 9, further comprising instructions that if executed enable the system to load a host application object to a host application domain.

11. The article of claim 9, further comprising instructions that if executed enable the system to load the check service add-in object to an add-in domain.

12. The article of claim 9, further comprising instructions that if executed enable the system to authorize a check document based on document information and tender amount.

13. The article of claim 9, further comprising instructions that if executed enable the system to return an array of printable text for a back side of a check document.

14. The article of claim 9, further comprising instructions that if executed enable the system to return an array of printable text for a receipt for the check document.

15. The article of claim 9, further comprising instructions that if executed enable the system to return configuration information to indicate whether check document information is retrieved by the check service add-in object or a host application object.

16. The article of claim 9, further comprising instructions that if executed enable the system to return configuration information to indicate whether printing is handled by the check service add-in object or a host application object.

17. An apparatus comprising a point of sale device having a processor coupled to a memory, the memory storing a point of sale host application object, a gift card service add-in object and a check service add-in object, the processor to execute the gift card service add-in object in response to application program interface commands to perform gift card service operations for the point of sale host application object, and the processor to execute the check service add-in object to perform check service operations for the point of sale host application service.

18. The apparatus of claim 17, comprising a software loader to load a host application object to a host application domain, and the gift card service add-in object and the check service add-in object to an add-in domain.

19. The apparatus of claim 17, comprising a gift card reader to read gift card information from a gift card.

20. The apparatus of claim 17, comprising a check reader to read check document information from a check.
